(19) United States
(12) Patent Application Publication
(10) Pub. No.: US 2014/0153059 A1
(43) Pub. Date: Jun. 5, 2014

(54) FACSIMILE APPARATUS CAPABLE OF PERFORMING DIVISION PRINTING OF DOCUMENT, METHOD OF CONTROLLING THE SAME, AND STORAGE MEDIUM

(71) Applicant: CANON KABUSHIKI KAISHA, Tokyo (JP)

(72) Inventor: Toyomi Hirao, Kawasaki-shi (JP)

(73) Assignee: CANON KABUSHIKI KAISHA, Tokyo (JP)

(21) Appl. No.: 14/097,498

(22) Filed: Dec. 5, 2013

(30) Foreign Application Priority Data
Dec. 5, 2012 (JP) 2012-266225

(51) Int. Cl. H04N 1/00

(52) U.S. Cl. CPC H04N 1/0044
USPC 358/449

(57) ABSTRACT

A facsimile apparatus which is improved in user friendliness for a user to print a document received by facsimile communication and is capable of performing division printing of the document. A sheet size of sheets on which the received document is to be printed is determined. In a preview process, when a document to be printed according to a determined sheet size is to be divided so as to be printed on a plurality of sheets, a preview image of the document in which a position where the document is to be divided is indicated is displayed on a display section. Further, in the preview process, the preview image is displayed on the display section by changing the position where the document is to be divided according to designation of the sheet size by a user.

### BACKGROUND OF THE INVENTION

1. Field of the Invention

The present invention relates to a facsimile apparatus capable of performing division printing of a document, a method of controlling the same, and a storage medium.

2. Description of the Related Art

There is frequently used an image forming apparatus which has image communication functions of a copy machine, a printer, a scanner, a facsimile apparatus, and so forth. The image forming apparatus generally includes a plurality of sheet feeders such that it can use recording materials of a plurality of sizes during printing (see e.g. Japanese Patent Laid-Open Publication No. H09-65045).

In such an image forming apparatus, when printing a received document, recording of the document is generally performed on a cut sheet. When the document is recorded on a cut sheet, if a sub-scanning length of an image of the document cannot be recorded within one sheet, the image is generally divided and recorded on a plurality of sheets (see e.g. Japanese Patent Laid-Open Publication No. H02-284570).

When printing a document received e.g. by facsimile communication, the image forming apparatus automatically selects, according to user settings, a recording material of an optimum size from the recording materials of the plurality of sizes, set in the sheet feeders of the image forming apparatus, and outputs the recording sheet of the optimum size.

Further, in recent years, there has also been proposed an image forming apparatus which, to save wasteful printing costs, temporarily stores a received document in a storage device, such as a hard disk, of the image forming apparatus, and prints out the stored document according to a user instruction.

In such an image forming apparatus, print processing is generally performed after a user confirms contents and an output image of the received document by executing a preview of the document. Further, there has also been proposed an image forming apparatus, in which, when printing a received document, if division recording is required, a division position is identified based on a sheet size according to a main scanning length of the received document, and the position of a division line is explicitly indicated during preview processing (see e.g. Japanese Patent Laid-Open Publication No. 2010-10974).

However, in the image forming apparatus disclosed in Japanese Patent Laid-Open Publication No. 2010-10974, the position of the division line explicitly indicated in the preview processing is determined according to size information notified by a DCS (Digital Command Signal) as a procedure signal issued from a transmission side, which has been received by facsimile communication.

Sizes that can be notified by the DCS are limited, and in a case where printing is performed on sheets of a size that cannot be declared by the DCS, there is brought about a problem that a division position during a print preview and an actual division position are different.

### SUMMARY OF THE INVENTION

The present invention provides a facsimile apparatus that is improved in user friendliness for the user to print a document received by facsimile communication and is capable of performing division printing of the document, a method of controlling the facsimile apparatus, and a storage medium.

In a first aspect of the present invention, there is provided a facsimile apparatus comprising a determination unit configured to determine a sheet size of sheets on which a document received by facsimile communication is to be printed, and a display control unit configured, in a case where a document to be printed according to the sheet size determined by the determination unit is to be divided so as to be printed on a plurality of sheets, to cause a preview image of the document in which a position where the document is to be divided is indicated to be displayed on a display section, wherein the display control unit causes the preview image to be displayed on the display section by changing the position where the document is to be divided according to designation of the sheet size by a user.

In a second aspect of the present invention, there is provided a method of controlling a facsimile apparatus, comprising determining a sheet size of sheets on which a document received by facsimile communication is to be printed, and displaying, in a case where a document to be printed according to the sheet size determined by said determining is to be divided so as to be printed on a plurality of sheets, a preview image of the document in which a position where the document is to be divided is indicated, on a display section, wherein said displaying includes displaying the preview image on the display section by changing the position where the document is to be divided according to designation of the sheet size by a user.

In a third aspect of the present invention, there is provided a non-transitory computer-readable storage medium storing a computer-executable program for causing a computer to execute a method of controlling a facsimile apparatus, wherein the method comprises determining a sheet size of sheets on which a document received by facsimile communication is to be printed, and displaying, in a case where a document to be printed according to the sheet size determined by said determining is to be divided so as to be printed on a plurality of sheets, a preview image of the document in which a position where the document is to be divided is indicated, on a display section, wherein said displaying includes displaying the preview image on the display section by changing the position where the document is to be divided according to designation of the sheet size by a user.

According to the present invention, it is possible to improve user friendliness for the user to print a document received by facsimile communication.

Further features of the present invention will become apparent from the following description of exemplary embodiments with reference to the attached drawings.

### BRIEF DESCRIPTION OF THE DRAWINGS

FIG. 1 is a schematic block diagram of an image forming apparatus according to an embodiment of the present invention.

FIGS. 2A to 2C are diagrams of recording material size list information used between an engine controller and a job controller appearing in FIG. 1.

FIG. 3 is a diagram of a layout selection table.

FIG. 4 is a flowchart of a layout information creation process executed by a CPU of the image forming apparatus shown in FIG. 1.

FIGS. 5A to 5D are diagrams of layout information created in the layout information creation process shown in FIG. 4.

FIG. 6 is a flowchart of a preview process executed by the CPU of the image forming apparatus.

FIG. 7 is a diagram useful in explaining addition of a division line in a step in FIG. 6.

FIG. 8 is a view of an example of a preview image displayed on a console section in FIG. 1.

FIGS. 9A and 9B are views of other examples of the preview image displayed on the console section shown in FIG. 1.

FIG. 10 is a flowchart of a layout information creation process executed by the CPU of the image forming apparatus when a size is designated by a user.

FIG. 11 is a flowchart of a printing process executed by the CPU of the image forming apparatus.

FIG. 12 is a view of a warning screen displayed on the console section.

### DESCRIPTION OF THE EMBODIMENTS

The present invention will now be described in detail below with reference to the accompanying drawings showing embodiments thereof.

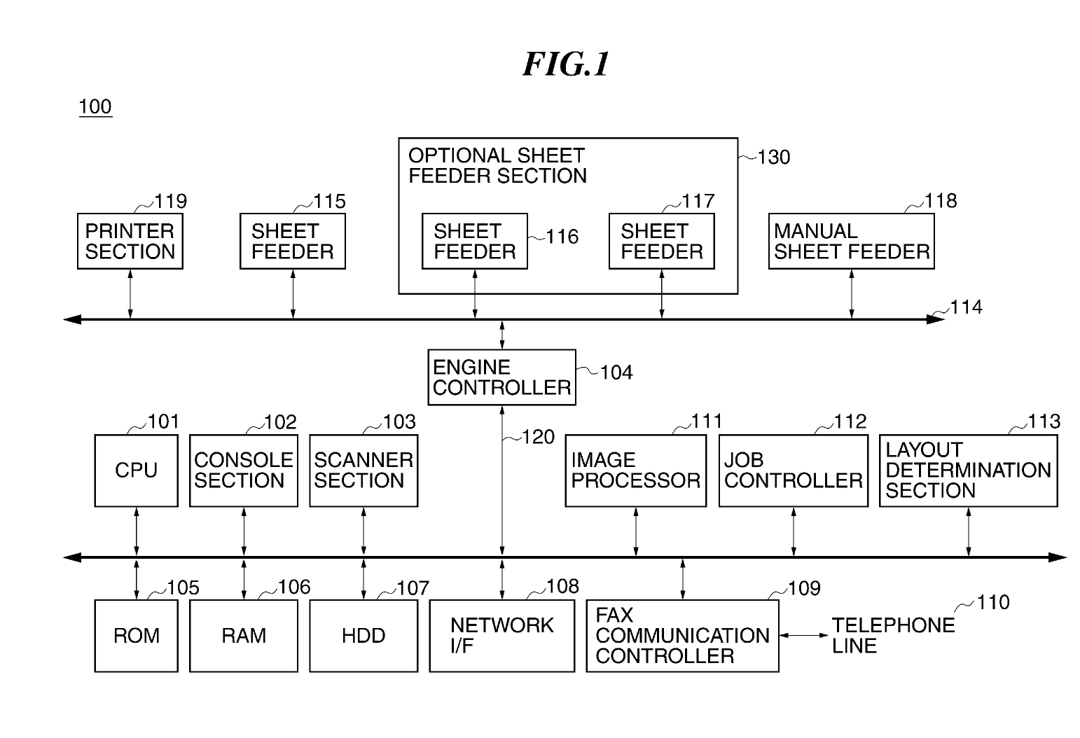

FIG. 1 is a schematic block diagram of an image forming apparatus 100 (facsimile apparatus) according to an embodiment of the present invention.

Referring to FIG. 1, a CPU 101 controls the image forming apparatus 100 based on control programs stored in a ROM 105.

A console section 102 displays e.g. windows, icons, messages, menus, and other user interface information, on a display screen of a display section, not shown, thereof. Further, the console section 102 includes a operating section, not shown, comprising various kinds of keys via which a user performs operations for copying, facsimile communication, and printing, and a screen pointing device with which the user operates an icon, a menu, etc. displayed on the display screen.

Further, the console section 102 displays a preview image and buttons for use in executing display of the preview image.

A scanner section 103 reads an original. An engine controller 104 performs control for printing (transferring and fixing) an image on a recording material, such as a sheet, based on data stored in the ROM 105 or a HDD (hard disk drive) 107.

The engine controller 104 incorporates a CPU, a RAM, and a ROM, none of which are shown, besides the CPU 101, the ROM 105, and a RAM 106. The engine controller 104 performs processing based on an engine control program read from the ROM incorporated therein. For example, the engine controller 104 receives control instructions issued from a job controller 112 via a communication section 120, and controls a printer section 119, sheet feeders 115, 116, and 117, and a manual sheet feeder 118 according to the received control instructions. The sheet feeders 116 and 117 form an optional sheet feeder section 130. Note that the sheet feeders 115, 116, and 117, and the manual sheet feeder 118 are sometimes collectively and simply referred to as the sheet feeders.

The ROM 105 stores various kinds of control programs and data. Processes shown in flowcharts, described hereinafter, are executed by the CPU 101 which reads programs from the ROM 105. The RAM 106 includes a work area for the CPU 101, an area for saving data in error handling, an area for loading the control programs, and so on. The HDD 107, which corresponds to a storage section, stores various kinds of control programs, documents received by facsimile communication, and so forth. In the following description, the facsimile communication is sometimes simply referred to as FAX.

The printer section 119 prints an image on a recording material. A network interface 108 is an interface for communicating with other terminals via a network, and receives e.g. a print job from a PC via the network.

A FAX communication controller 109 performs facsimile communication via a telephone line 110. An image processor 111 performs image processing including encoding, decoding, scaling, rotation, and division of an image, by using software executed by the CPU 101 and hardware specialized for specific processing, such as rotation and scaling of an image. In the present embodiment, when division recording of a received document is performed, processing for adding a line explicitly indicating a division position to the document has to be performed. This processing is realized by a module of software of the image processor 111.

The job controller 112 generates a job for receiving a document by FAX, and a job for each of a plurality of types of processing on a document received via the network, such as printing, transfer, and display of preview images, whereby each processing is executed.

A document received via the telephone line 110 is stored in the HDD 107. At this time, document information as metadata comprising a document ID, the number of pages included in the document, an encoding method, and a time point when the document has been received, is added to the document. The document received by FAX is stored in the HDD 107 by the job generated by the job controller 112, and hence the job controller 112 corresponds to a storage unit.

The engine controller 104 has a control bus 114 connected thereto for controlling the sheet feeders, the printer section 119, and so forth. The sheet feeders 115, 116, and 117, and the manual sheet feeder 118 are connected to the control bus 114.

In the present embodiment, the optional sheet feeder section 130 including the sheet feeders 116 and 117 are removable, and if it is not mounted, only the sheet feeder 115 and the manual sheet feeder 118 are used. In performing printing, the engine controller 104 instructs a selected one of the sheet feeders 115, 116, and 117, and the manual sheet feeder 118 connected to the control bus 114 to feed a recording material.

Further, the engine controller 104 is configured to be capable of detecting whether or not the optional sheet feeder section 130 including the sheet feeders 116 and 117 is connected to the control bus 114. To detect whether or not the optional sheet feeder section 130 is connected to the control bus 114, there are used any of detection methods, such as a loopback detection method using an electric signal, and a hardware-related detection method using a dongle.

Furthermore, the engine controller 104 is capable of determining the sizes of recording materials which can be fed by the sheet feeders 115, 116, and 117, and the manual sheet feeder 118, respectively. Information on the sizes of recording materials, a sheet feeder count, and the capabilities of the sheet feeders is notified to a layout determination section 113.

The layout determination section 113 receives information on the sheet feeders 115, 116, and 117, and the manual sheet feeder 118 from the engine controller 104. Then, the layout determination section 113 determines an optimum size of a recording material to be used based on the information on the sheet feeders 115, 116, and 117, and the manual sheet feeder 118, and a print job or a preview job generated by the job controller 112, and performs print image generation and preview image generation.

The communication section 120 realizes communication between the engine controller 104 and the job controller 112 by UART (Universal Asynchronous Receiver Transmitter) communication using e.g. the RS232C interface.

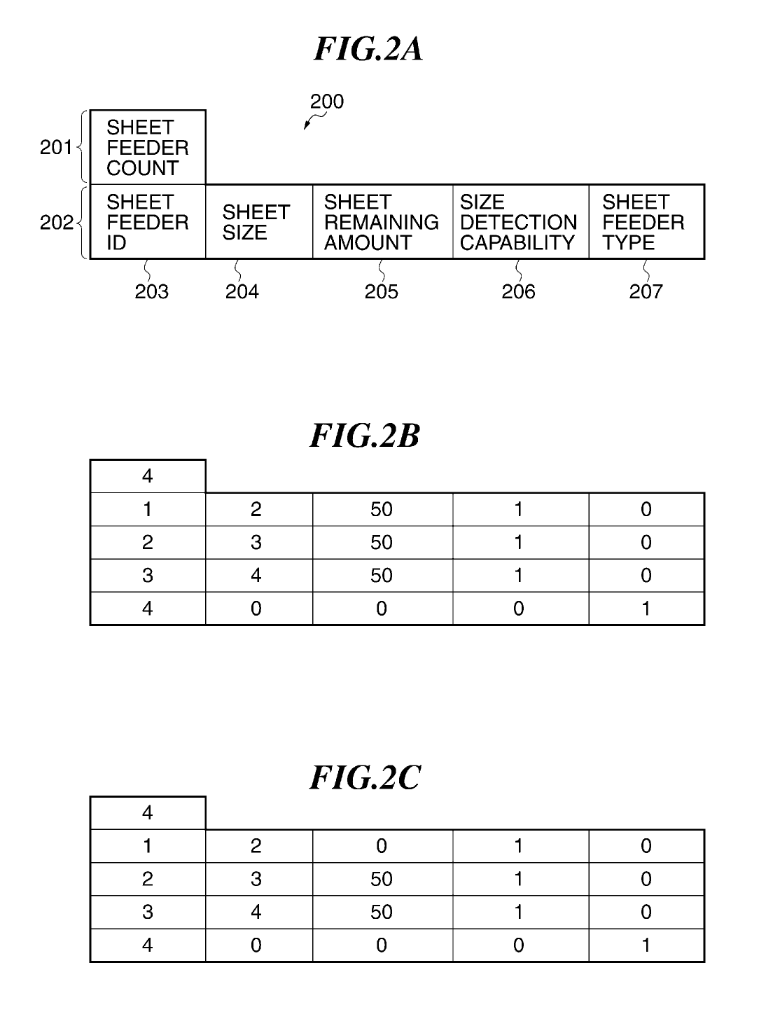

FIGS. 2A to 2C are diagrams of recording material size list information 200 used between the engine controller 104 and the job controller 112 appearing in FIG. 1.

FIG. 2A shows displayed items of the recording material size list information. Referring to FIG. 2A, the displayed items of the recording material size list information include the sheet feeder count, denoted by reference numeral 201, which is an overall sheet feeder information field, and a set 202 of recording-material information fields. The sheet feeder count 201 indicates the number of sheet feeders provided in the image forming apparatus 100. In the present embodiment, the four sheet feeders, i.e. the sheet feeders 115, 116, and 117, and the manual sheet feeder 118 are provided, and hence the sheet feeder count 201 is four. The number of provided sets 202 of recording-material information fields is equal to the number indicated by the sheet feeder count 201. Therefore, in the present embodiment, four sets 202 of recording-material information fields are provided, as shown in FIG. 2B.

Each set 202 of recording-material information fields includes respective fields of a sheet feeder ID 203, a sheet size 204, a sheet remaining amount 205, a size detection capability 206, and a sheet feeder type 207.

The sheet feeder ID 203 is an ID (identifier) for identifying each sheet feeder. The sheet size 204 indicates a size of a recording material which can be fed by an associated one of the sheet feeders. In the illustrated example, an A3-size recording material is indicated by 1, and an A4-size recording material is indicated by 2. Particularly, 0 indicates that the size of a recording material is not known. The sheet remaining amount 205 indicates the remaining amount of the recording material in an associated one of the sheet feeders and is represented by a value of 0 to 100(%).

The size detection capability 206 indicates whether or not an associated one of the sheet feeders has a capability of detecting the size of a recording material. If the associated sheet feeder has the capability, the size detection capability is indicated by 1, whereas if not, the same is indicated by 0.

In the above-described sheet size 204, 0 for indicating that the size of a recording material is not known is set if a sheet feeder has no capability of detecting the size of a recording material, or if it is impossible to detect the size of a recording material for some reason. The sheet feeder type 207 indicates the type of an associated one of the sheet feeders. If the type of the associated sheet feeder is a manual sheet feeder, it is indicated by 1, whereas if not, it is indicated by 0.

FIGS. 2B and 2C show recording material size list information in which a A4-size recording material is set in the sheet feeder 115, a A5-size recording material is set in the sheet feeder 116, and a B5-size recording material is set in the sheet feeder 117, as an example of the recording material size list information 200. Particularly, the example illustrated in FIG. 2B shows the recording material size list information 200 in a case where the sheet remaining amount 205 of a recording material set in a sheet feeder indicated by the sheet feeder ID 203 of 4 is 0%, and the example illustrated in FIG. 2C shows the recording material size list information 200 in a case where the sheet remaining amounts 205 of recording materials set in the respective sheet feeders indicated by the sheet feeder IDs 203 of 1 and 4 are 0%.

The above-described recording material size list information is received by the engine controller 104, and is stored in the RAM 106.

Referring again to FIG. 1, to execute a layout creation process, the layout determination section 113 acquires the recording material size list information 200 from the RAM 106, and executes the layout creation process. Specifically, the layout determination section 113 selects an optimum size from the sizes of recording materials set in the sheet feeders 115, 116, and 117, and the manual sheet feeder 118, and generates layout information for use in instructing image processing, such as image division and image size reduction, according to the selected size of a recording material. Further, a layout selection table is created in the layout creation process.

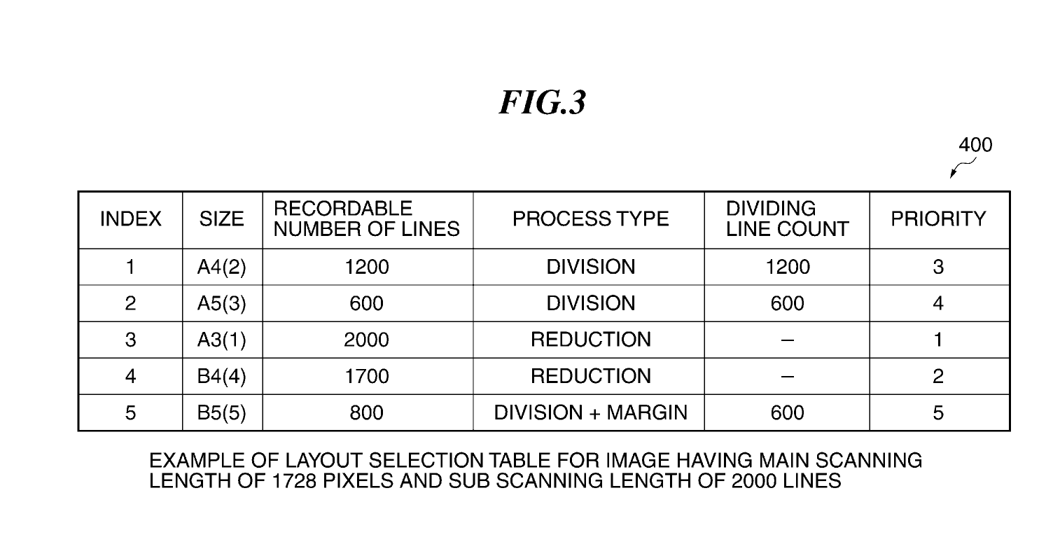

FIG. 3 is a diagram of the layout selection table.

Referring to FIG. 3, the layout selection table 400 has fields of indexes, sizes, recordable numbers of lines, process types, dividing line counts, and priorities. Further, the layout selection table 400 in FIG. 3 shows an example created in a case where an image of a received document has a main scanning length of 1728 in terms of the number of pixels and a sub-scanning length of 2000 in terms of the number of lines.

The indexes are identifiers in the layout selection table 400. The sizes indicate sheet sizes, and accompanying numerals in parentheses indicate represent sheet sizes described with reference to FIGS. 2A to 2C.

The recordable numbers of lines each represent a value calculated by subtracting a total number of lines of a margin, a header, and a footer provided when recording a document, from a value of the sub-scanning length of a recording material in terms of the number of lines. Each recordable number of lines is calculated by taking into account the value of a maximum scaling ratio set in advance by the user for use in a case where an image of the document is recorded by reducing the size thereof. In this case, the recordable number of lines sometimes becomes larger than an actual sub-scanning length of the recording material.

The process types are each indicated by a setting of “division” indicating that a document is divided and printed on a plurality of sheets of a recording material, and a setting of “reduction” indicating that an image is reduced in size such that it can be printed on a single sheet of the recording material.

The dividing line counts each indicate a sub-scanning length of an image which can be recorded on one sheet of a recording material when the above-mentioned division printing is performed, and is used as a reference value for calculating the number of sheets of the recording material required for the division printing. For example, when division printing is performed on an A4-size recording material using the layout selection table 400, layout information is created such that lines in a range of 1st to 1200th lines are printed on a first sheet of the recording material, and lines in a range of 1201st to 2000th lines are printed on a second sheet of the recording material.

The priorities each indicate a priority of a layout indicated by an associated index, and is made use of in a layout information creation process, described hereinafter.

Further, in the layout information creation process, described hereinafter, Imax and Pmax in the layout selection table 400 are used. Imax indicates a maximum value of the index, and is equal to 5 in the case of FIG. 3. Further, Pmax indicates a maximum value of priority-indicative values, and is equal to 5 in the case of FIG. 3.

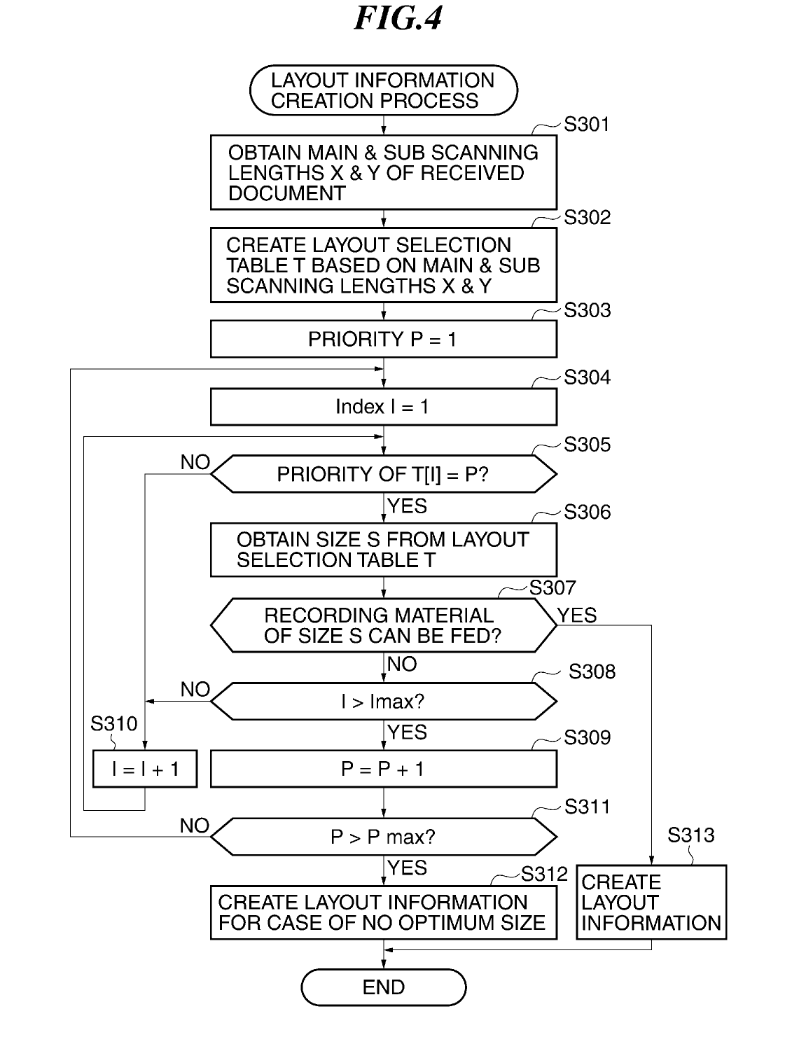

FIG. 4 is a flowchart of the layout information creation process executed by the CPU 101 shown in FIG. 1.

Referring to FIG. 4, a main scanning length X and a sub scanning length Y of a received document, which is a document received by FAX, are obtained (step S301). Then, a layout selection table T described with reference to FIG. 3 is created based on the main scanning length X and the sub scanning length Y (step S302).

Then, 1 is substituted into a priority P (step S303). Further, 1 is substituted into I as an index (step S304).

Next, it is determined whether or not the priority of T[I] is P (step S305). Here, T[I] indicates data on a row of the layout selection table, associated with the index I, and hence the priority of T[I] indicates a priority on the row associated with the index I.

If it is determined in the step S305 that the priority of T[I] is not P (NO to the step S305), I is incremented by 1 (step S310), and the process returns to the step S305.

On the other hand, if it is determined in the step S305 that the priority of T[I] is P (YES to the step S305), a sheet size S of T[I] is obtained (step S306).

Then, it is determined whether or not sheets of a recording material of the sheet size S can be fed (step S307). This can be determined based on the sheet size 204 and the sheet remaining amount 205 of the recording material size list information 200 described with reference to FIGS. 2A to 2C.

If it is determined in the step S307 that the sheets of the recording material of the sheet size S can be fed (YES to the step S307), layout information is created based on the process type and the dividing line count of T[I] (step S313), followed by terminating the layout information creation process.

On the other hand, if it is determined in the step S307 that the sheets of the recording material of the sheet size S cannot be fed (NO to the step S307), it is determined whether or not I>Imax holds (step S308). If it is determined in the step S308 that I>Imax does not hold (NO to the step S308), the process proceeds to the above-described step S310.

On the other hand, if it is determined in the step S308 that I>Imax holds (YES to the step S308), P is incremented by 1 (step S309), and it is determined whether or P>Pmax holds (step S311). This means that it is determined whether or not the process has been performed on all the priorities.

If it is determined in the step S311 that P>Pmax does not hold (NO to the step S311), the process returns to the above-described step S304. On the other hand, if it is determined in the step S311 that P>Pmax holds (YES to the step S311), layout information for a case where there is no recording material of the optimum size is created (step S312), followed by terminating the layout information creation process.

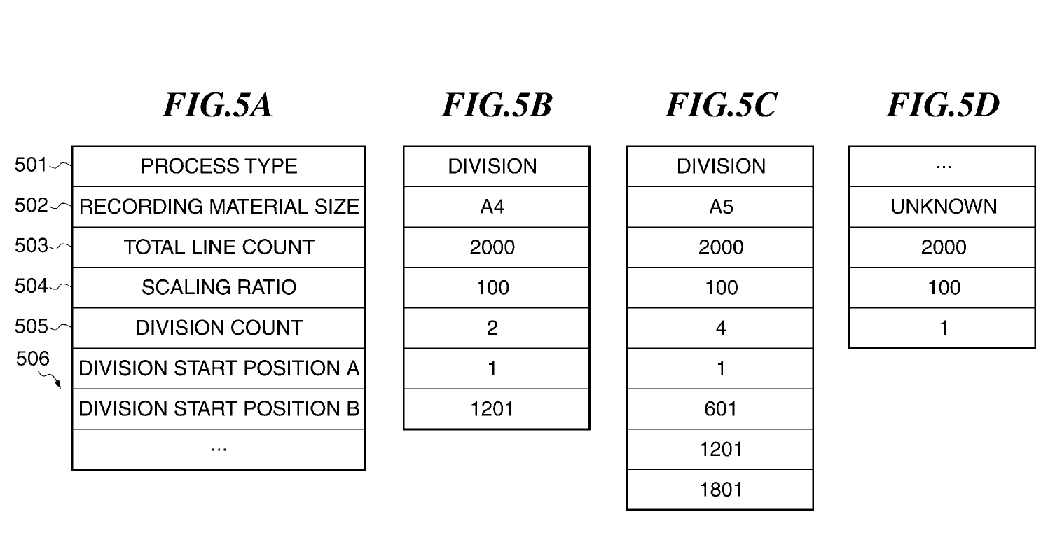

FIGS. 5A to 5D are diagrams of the layout information created in the layout information creation process shown in FIG. 4.

FIG. 5A shows items of the layout information. The items of the layout information include a process type 501, a recording material size 502, a total line count 503, a scaling ratio 504, a division count 505, and division start positions 506.

As the process type 501, a process type in the layout selection table is set. As the recording material size 502, a size in the layout selection table is set. As the total line count 503, the sub scanning length Y is set.

As the scaling ratio 504, a reduction ratio expressed in units of percent is set when the process type is reduction. As the division count 505, for a case where a plurality of pages are to be printed, the number of pages is set. The number of provided division start positions 506 is equal to the number indicated by the division count 505. In the case of the illustrated example, a start position on a first page is indicated as a division start position A, and a start position on a second page is indicated as a division start position B.

FIG. 5B shows an example of layout information created in a case where the recording material size list information is the recording material size list information shown in FIG. 2B.

In the recording material size list information shown in FIG. 2B, the recording materials having sizes of A4 (2), A5 (3), and B4 (4) are set in the sheet feeders. In the layout information created based on this information by the layout creation process, the A4-size recording material is set as the recording material, and division is set as the process type.

In this case, since the recordable number of lines per one sheet of the recording material is 1200, the layout information is created such that lines in a range of 1st to 1200th lines are printed on a first sheet of the recording material and lines in a range of 1201st to 2000th lines are printed on a second sheet of the recording material.

FIG. 5C shows an example of layout information created in a case where the recording material size list information is the recording material size list information shown in FIG. 2C.

According to the recording material size list information shown in FIG. 2C, sheets of the A4-size recording-material cannot be fed, and hence the A5-size recording material having a next-highest priority is selected as the recording material for printing, and layout information is created such that an image is divided and printed on four sheets of the recording material.

FIG. 5D is a diagram of the layout information created in the step S312 in FIG. 4 in a case where there is no recording material of the optimum size.

In the layout information shown in FIG. 5D, the process type 501 is blank and the recording material size 502 is unknown.

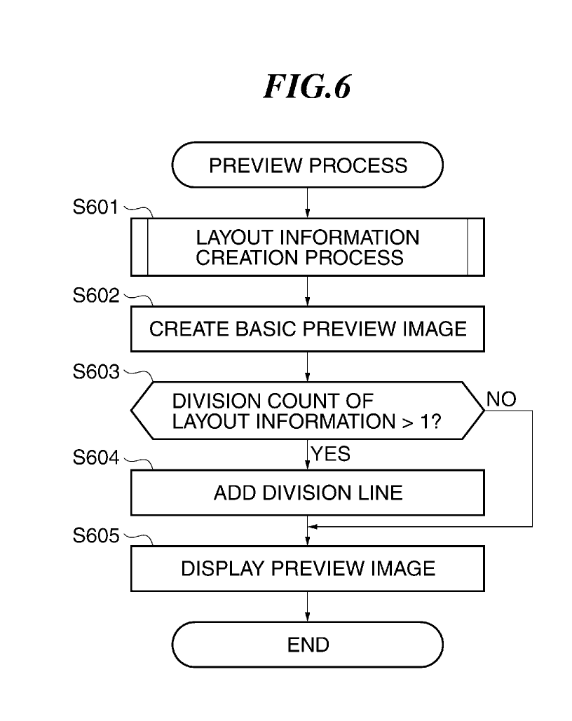

FIG. 6 is a flowchart of a preview process executed by the CPU 101 appearing in FIG. 1.

Referring to FIG. 6, when the preview process is instructed by the user, the layout information creation process described with reference to FIG. 4 is executed (step S601). Next, a basic preview image is created using created layout information (step S602).

The basic preview image is created by reading out a JBIG-encoded document from the HDD 107, and decoding the document by the image processor 111. The decoded document is stored in the RAM 106. When the document stored in the RAM 106 is a monochrome image, the document is represented in a one bit-per-pixel format using a 0 bit to represent a white pixel and a 1 bit to represent a black pixel.

Then, it is determined whether or not the division count of the layout information>1 holds (step S603). If it is determined in the step S603 that the division count>1 does not hold (NO to the step S603), the process proceeds to a step S605.

On the other hand, if it is determined in the step S603 that the division count>1 holds (YES to the step S603), division lines are added to the basic preview image at division start positions on a second page et seq. indicated by the layout information (step S604).

Next, a preview image is displayed on the console section 102 (step S605), followed by terminating the preview process. This preview process corresponds to the operation of a display control unit configured, in a case where a document to be printed according to the sheet size determined by a determination unit is to be divided so as to be printed on a plurality of sheets, to cause a preview image of the document in which a position where the document is to be divided is indicated to be displayed on a display section.

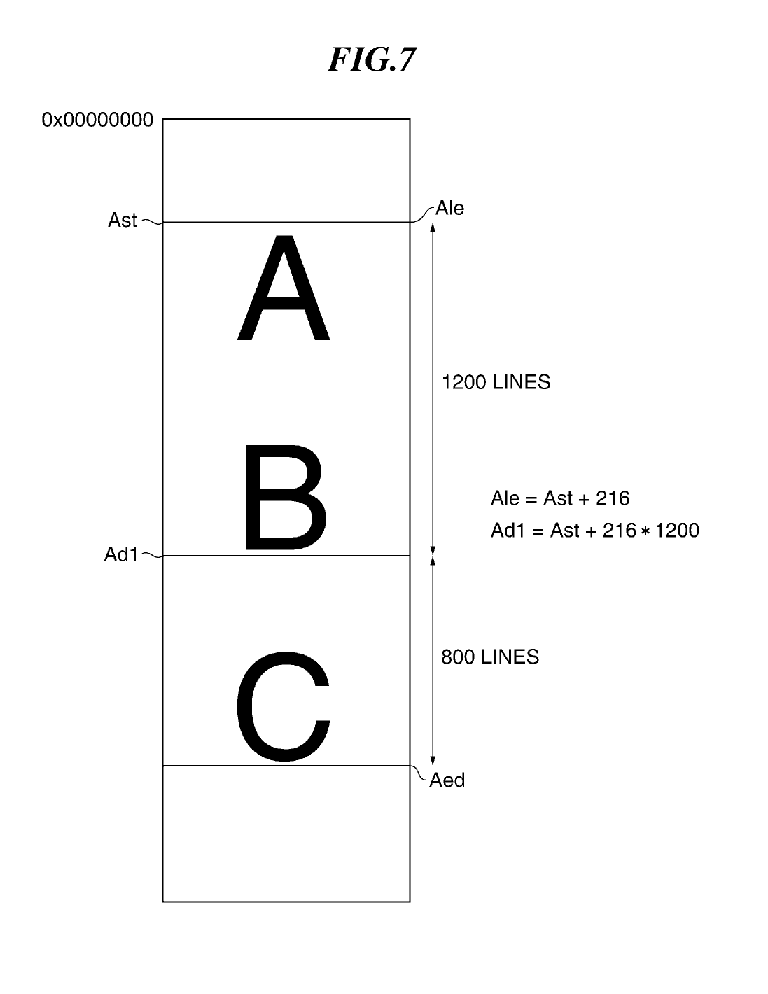

FIG. 7 is a diagram useful in explaining the addition of the division lines in the step S604 in FIG. 6.

In FIG. 7, a main scanning length of a document to be processed is set to 1728 (pixels), and a sub-scanning length of the document is set to 2000 (lines), by way of example.

In FIG. 7, it is assumed that the document starts with an Ast (Address Start) in the RAM 106. Ale represents an address indicating an end position of a first row starting with Ast, and is calculated as Ale=Ast+1728/8=Ast+216.

An address Aed (Address End) at a trailing end of the document is calculated as Ast+1728/8*2000. Ad1 represents an address indicating a start position of the division line. A division start position field of the layout information is referred to for identifying a line to which the division line is to be added.

In the case of the layout information shown in FIG. 5B, since the division count is 2, and the field of a division start position 2 indicates 1201, Ad1 is calculated as Ast+(1728/8)*1200=Ast+216*1200.

To add a black line as the division line, the image processor 111 overwrites 0xFF indicating the black line, in addresses in a range up to 216 bytes from Ad1.

Then, the console section 102 is caused to display a range from the address Ast to the address Aed, whereby the preview image is displayed.

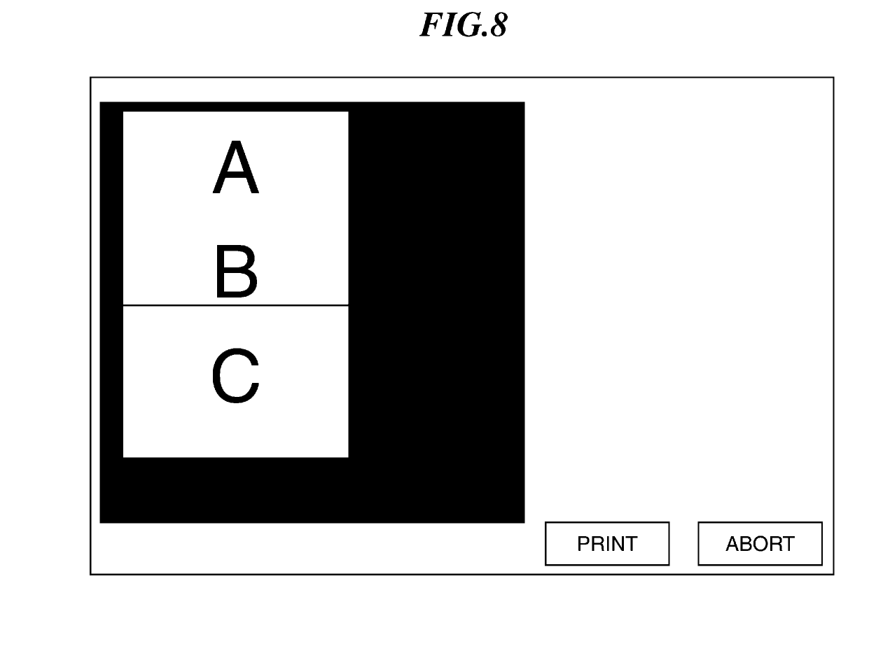

FIG. 8 is a view of an example of the preview image displayed on the console section 102 appearing in FIG. 1.

In the preview image in FIG. 8, the black line described with reference to FIG. 7 is displayed.

As described above, if a document is to be divided, a division position is explicitly indicated when a preview image is displayed, and hence a preview image viewed by the user and a printed image match each other. This makes it possible for the user to obtain intended output results. Note that the user sometimes wishes to designate a desired size to set a division position. Therefore, in the following, a description will be given of a case where the user designates a size.

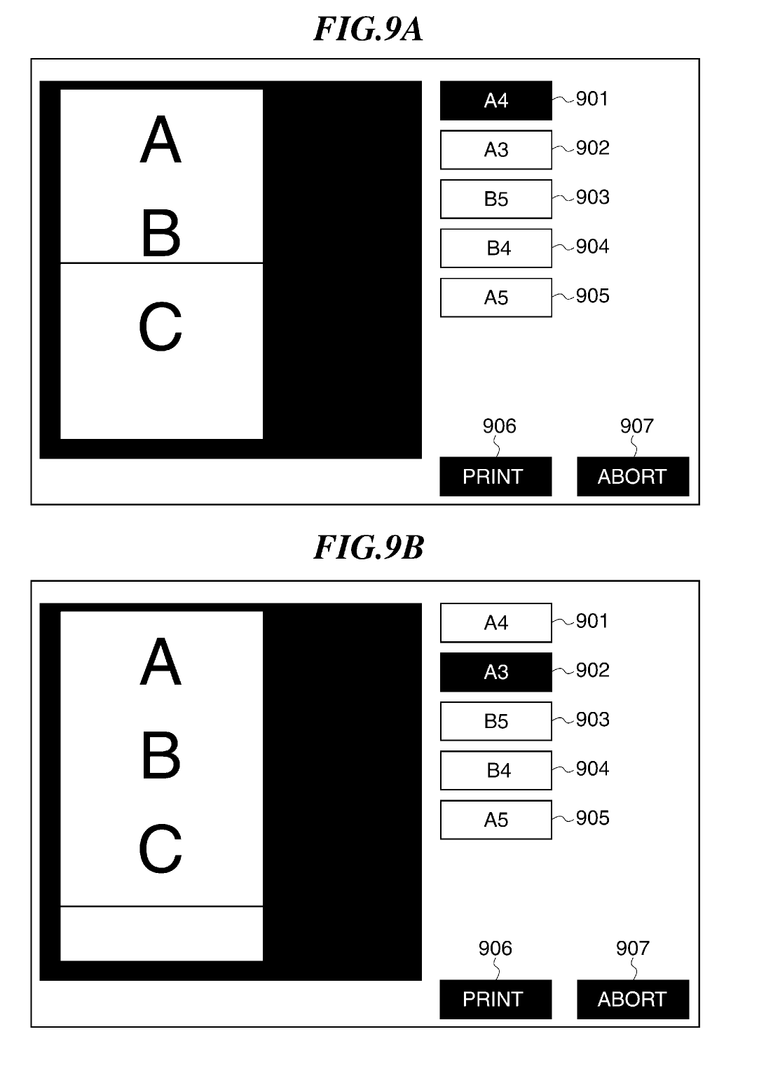

FIGS. 9A and 9B are views of other examples of the preview image displayed on the console section 102 shown in FIG. 1.

The preview image illustrated in FIG. 9A is displayed on the console section 102, when the user instructs display of the preview image in a state where recording materials of three sizes, i.e. A4, B5, and A5, are set in the sheet feeders.

In FIG. 9A, keys 901 to 905 are used for the user to designate one of the sizes of the recording materials by a touch operation on the console section 102.

When the preview image is displayed on the console section 102, one of the keys 901 to 905, associated with the size of recording materials set based on the layout information, is displayed in greyed-out text (shown in a highlighted form in the figure). By displaying in greyed-out text, it is clearly indicated which recording material size is applied to the current preview of an image of the document to be printed.

Further, a key 906 is used for printing the image on the recording material of the greyed-out size. When the user presses the key 906, printing processing is executed. Further, a key 907 is used for aborting the display of the preview image.

FIG. 9B is a view of a preview image displayed when the user presses the key 902 to select A3 as the size of a recording material.

As shown in FIG. 9B, the key 902 associated with A3 is greyed out (shown in a highlighted form in the figure) in place of the key 901.

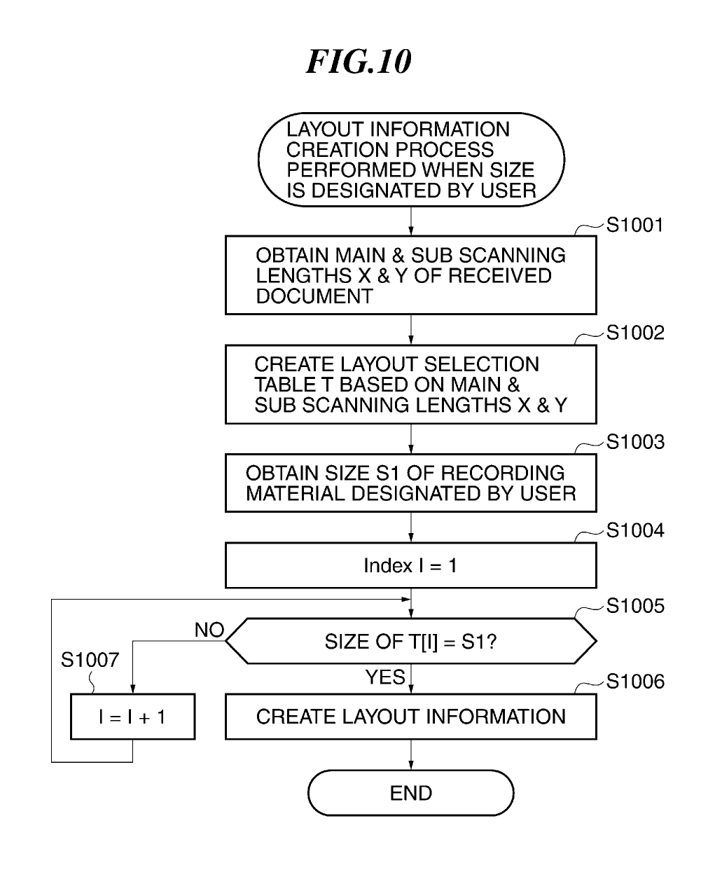

FIG. 10 is a flowchart of the layout information creation process executed by the CPU 101 of the image forming apparatus when a size is designated by the user.

Referring to FIG. 10, a main scanning length X and a sub scanning length Y of a received document, which is a document received by FAX, are obtained (step S1001). Then, the layout selection table T described with reference to FIG. 3 is created based on the main scanning length X and the sub scanning length Y (step S1002). Since a recording material of a size which can be designated by the user is a recording material which can be fed, the created layout selection table T naturally includes information of a recording material of the size designated by the user.

Next, the size S1 of the recording material designated by the user is obtained (step S1003), and then 1 is substituted into I, which is an index (step S1004). The above-described step S1003 corresponds to the operation of a designation unit configured to designate the size of a recording material on which a document stored in the storage section is to be printed according to an operation by the user.

Then, it is determined whether or not the size of T[I] is equal to S1 (step S1005). If it is determined in the step S1005 that the size of T[I] is not equal to S1 (NO to the step S1005), I is incremented by 1 (step S1007), and the process returns to the step S1005.

On the other hand, if it is determined in the step S1005 that the size of T[I] is equal to S1 (YES to the step S1005), layout information is created based on the process type and the dividing line count of T[I] (step S1006), followed by terminating the layout information creation process. After that, a preview image is displayed by processing executed in the step S602 et seq. in FIG. 6.

Although the flowchart appearing in FIG. 10 describes a process performed on the recording material of a size which can be fed, the process may be configured such that the user can designate a recording material of a size which cannot be fed at the current time point. For example, if it is configured that the user can designate the A3-size recording material even thought it cannot be fed, the preview image shown in FIG. 9B is displayed.

When the key 906 is pressed by the user in this state, a print job is generated by the job controller 112. Then, layout information is created based on the size designated by the user in the FIG. 10 layout information creation process, and is stored in the RAM 106.

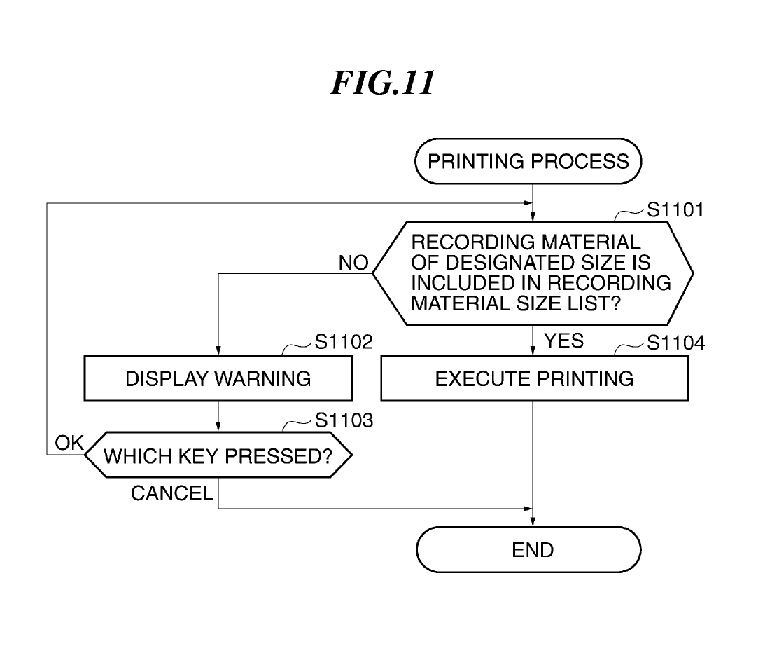

FIG. 11 is a flowchart of a printing process executed by the CPU 101 of the image forming apparatus.

Referring to FIG. 11, it is determined whether or not the recording material of the size designated by the user and indicated by the layout information is included in the recording material size list information 200 (step S1101). If it is determined in the step S1101 that the recording material of the size designated by the user is included in the recording material size list information 200 (YES to the step S1101), printing is executed (step S1104), followed by terminating the present process.

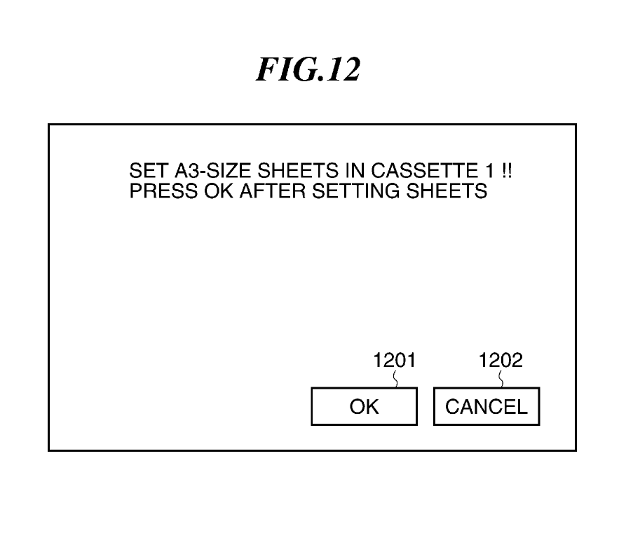

On the other hand, if it is determined in the step S1101 that the recording material of the size designated by the user is not included in the recording material size list information 200 (NO to the step S1101), a warning screen is displayed on the console section 102 (step S1102). FIG. 12 is a view of the warning screen displayed on the console section 102. On the warning screen, the user can select one of keys 1201 and 1202. The key 1201 is pressed when the user has set sheets of the A3-size recording material in a sheet feeder. On the other hand, the key 1202 is pressed when the user cancels printing. As described above, in the present embodiment, when the document cannot be printed on the recording material of the size designated by the user, a message indicating the fact is displayed.

Then, it is determined whether or not one of the keys 1201 and 1202 has been pressed (step S1103). If it is determined in the step S1103 that the key 1202 has been pressed (cancel is selected), the present process is terminated.

On the other hand, if it is determined in the step S1103 that the key 1201 has been pressed (OK is selected), the process returns to the step S1101. Note that when the user has set sheets of the A3-size recording material, and presses the key 1201, the layout determination section 113 inquires of the engine controller 104 as to sheet feeder information, whereby the recording material size list information 200 is regenerated. Therefore, when the process returns to the step S1101, the answer to the question of the step S1101 becomes affirmative (YES).

Thus, after confirming the division position on a preview screen, the user executes the printing process. This makes it possible to obtain an intended printing result.

According to the above-described embodiment, when a document is to be printed on a recording material, if the document is divided and printed on a plurality of sheets of the recording material, a preview image of the document in which a position where the document is to be divided is indicated is displayed. Further, the position where the document is to be divided can be changed and displayed according to the size of a recording material designated by the user. This makes it possible to improve user friendliness for the user to print a document received by facsimile communication.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2012-266225 filed Dec. 5, 2012, which is hereby incorporated by reference herein in its entirety.

What is claimed is:

1. A facsimile apparatus comprising:
a determination unit configured to determine a sheet size of sheets on which a document received by facsimile communication is to be printed; and
a display control unit configured, in a case where a document to be printed according to the sheet size determined by said determination unit is to be divided so as to be printed on a plurality of sheets, to cause a preview image of the document in which a position where the document is to be divided is indicated to be displayed on a display section,
wherein said display control unit causes the preview image to be displayed on the display section by changing the position where the document is to be divided according to designation of the sheet size by a user.

2. The facsimile apparatus according to claim 1, wherein said determination unit determines the sheet size according to a line count indicative of the number of lines to be printed based on the document.

3. The facsimile apparatus according to claim 1, wherein said display control unit causes sheet sizes which can be designated to be displayed on the display section.

4. The facsimile apparatus according to claim 1, further comprising a storage unit configured to store a line count serving as a reference for division, for each of the plurality of sheets.

5. A method of controlling a facsimile apparatus, comprising:
determining a sheet size of sheets on which a document received by facsimile communication is to be printed; and
displaying, in a case where a document to be printed according to the sheet size determined by said determining is to be divided so as to be printed on a plurality of sheets, a preview image of the document in which a position where the document is to be divided is indicated, on a display section,
wherein said displaying includes displaying the preview image on the display section by changing the position where the document is to be divided according to designation of the sheet size by a user.

6. The method according to claim 5, wherein said determining includes determining the sheet size according to a line count indicative of the number of lines to be printed based on the document.

7. The method according to claim 5, wherein said displaying includes displaying sheet sizes which can be designated on the display section.

8. The method according to claim 5, further comprising storing a line count serving as a reference for division, for each of the plurality of sheets.

9. A non-transitory computer-readable storage medium storing a computer-executable program for causing a computer to execute a method of controlling a facsimile apparatus,
wherein the method comprises:
determining a sheet size of sheets on which a document received by facsimile communication is to be printed; and
displaying, in a case where a document to be printed according to the sheet size determined by said determining is to be divided so as to be printed on a plurality of sheets, a preview image of the document in which a position where the document is to be divided is indicated, on a display section,
wherein said displaying includes displaying the preview image on the display section by changing the position where the document is to be divided according to designation of the sheet size by a user.
